(19) United States
(12) Patent Application Publication
(10) Pub. No.: US 2024/0103550 A1
(43) Pub. Date: Mar. 28, 2024

(54) LOW-DROPOUT REGULATOR WITH IMPROVED GAIN BANDWIDTH AND BIAS GENERATION

(71) Applicant: Apple Inc., Cupertino, CA (US)

(72) Inventors: Guillaume Gourlat, Munich (DE); Mina Mofreh Gad Elsayed Abdallah, Munich (DE); Adrien F Vargas, Munich (DE)

(21) Appl. No.: 18/102,643

(22) Filed: Jan. 27, 2023

Related U.S. Application Data
(60) Provisional application No. 63/409,191, filed on Sep. 22, 2022.

(51) Int. Cl. G05F 1/565; G05F 3/26

(52) U.S. Cl. CPC G05F 1/565; G05F 3/26

(57) ABSTRACT

A fast loop amplifier provides low-dropout (LDO) regulation for a frequency range. In one embodiment, the fast loop amplifier may include a two-stage amplifier that decouples gain from bandwidth. In another embodiment, the LDO regulator may include an alternating current coupling capacitor having increased capacitance (e.g., twice that of a load capacitance) and adding one or more gate blocking capacitors. The load capacitance may include a sum of a capacitance of the one or more gate blocking capacitors and parasitic capacitances of the fast loop amplifier. The AC coupling capacitor and the one or more gate blocking capacitors may improve base open-loop power supply rejection ratio and load regulation. In yet another embodiment, bias generation circuitry of the fast loop amplifier may include an amplifier coupled to the fast loop amplifier that reduces gain variations across process, voltage, and/or temperature, and maintains current density with respect to gain programing.

### CROSS-REFERENCE TO RELATED APPLICATIONS

This application claims priority to U.S. Provisional Application No. 63/409,191, filed Sep. 22, 2022, entitled “LOW-DROPOUT REGULATOR WITH IMPROVED GAIN BANDWIDTH AND BIAS GENERATION,” the disclosure of which is incorporated by reference in its entirety for all purposes.

### BACKGROUND

The present disclosure relates generally to wireless communication, and more specifically to regulating voltage for wireless communication.

In a wireless communication device, a low-dropout (LDO) regulator may regulate voltage used to facilitate wireless communication. However, gain bandwidth product of an amplifier of the LDO regulator may be dependent on a bandwidth of an input signal. Moreover, the LDO regulator may not have sufficient noise (e.g., out-of-band emission) rejection or load regulation performance. Additionally, performance of the LDO regulator may vary excessively with variations in process, voltage, and/or temperature.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a two-stage amplifier is described. The two-stage amplifier may include a first stage comprising a first transistor, a second transistor coupled to the first transistor, and a third transistor coupled to the first transistor and the second transistor. A gate of the third transistor may receive an input signal. The two-stage amplifier may include a second stage including a fourth transistor and a fifth transistor coupled to the fourth transistor. A gate of the fifth transistor may be coupled to the first transistor, the second transistor, and the third transistor. The gate of the fifth transistor may receive an amplified signal based on the input signal. The fifth transistor may provide an output signal based on the amplified signal.

In another embodiment, a low-dropout regulator circuit is described. The low-dropout regulator circuit may include a two-stage amplifier. A first stage of the two-stage amplifier may provide an amplified signal based on receiving an input signal. A second stage of the two-stage amplifier may provide a first output signal. The second stage may have a wider bandwidth compared to the first stage. The low-dropout regulator circuit may include an alternating current coupling capacitor coupled to an output port of the two-stage amplifier, a coupling capacitor coupled to the alternating current coupling capacitor, and an output transistor that may receive a first input signal at a first terminal and provide a second output signal at a second terminal. The second terminal may be coupled to an input port of the two-stage amplifier and a third terminal of the output transistor may be coupled to the coupling capacitor and the alternating current coupling capacitor.

In yet another embodiment, low-dropout circuitry is described. The low-dropout circuitry may include a low-dropout regulator circuit comprising a two-stage amplifier having a plurality of transistors. Moreover, the low-dropout circuitry may include a bias generation circuit including an operational amplifier, a first current mirror circuit, a first replica transistor including a first terminal coupled to an input voltage and a second terminal being coupled to an output of the operational amplifier and a first transistor of the plurality of transistors, and a third terminal. The bias generation circuit may also include a second replica transistor including a fourth terminal coupled to the input voltage, a fifth terminal coupled to a load bias circuit and a second transistor of the plurality of transistors, and a sixth terminal coupled to an inverting input of the operational amplifier. The bias generation circuit may also include a third replica transistor including a seventh terminal coupled to the first current mirror circuit, an eighth terminal of the third replica transistor, and a third transistor of the plurality of transistors, the eighth terminal, and a ninth terminal coupled to a ground connection.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device including a low-dropout (LDO) circuitry, according to embodiments of the present disclosure;

FIG. 2 is a functional diagram of the electronic device of FIG. 1, according to embodiments of the present disclosure;

FIG. 3 is a schematic diagram of a transmitter of the electronic device of FIG. 1 including the LDO circuitry, according to embodiments of the present disclosure;

FIG. 4 is a schematic diagram of a receiver of the electronic device of FIG. 1 including the LDO circuitry, according to embodiments of the present disclosure;

FIG. 5 is a circuit diagram of a two-stage amplifier of an LDO regulator circuit of the LDO circuitry of FIGS. 3 and 4 including a first stage for amplifying input signals with a desired gain and a second stage for providing an amplified signal with a desired bandwidth, according to embodiments of the present disclosure;

FIG. 6 is a circuit diagram of the two-stage amplifier of FIG. 5 coupled to an effective load capacitor of an LDO regulator circuit that includes the two-stage amplifier, according to embodiments of the present disclosure;

FIG. 7 is a circuit diagram of the LDO regulator circuit including the two-stage amplifier of FIG. 5, according to embodiments of the present disclosure; and

FIG. 8 is a bias generation circuit of the LDO circuitry of FIGS. 3 and 4, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to supply voltage regulation in wireless communication devices. In a wireless communication device, low-dropout (LDO) circuitry may provide regulated supply voltage to one or more electrical components to facilitate wireless communication. The LDO circuitry may include an LDO regulator circuit and a bias generation circuit. The LDO regulator circuit may provide the supply voltage based on receiving biasing signals from the bias generation circuit. The LDO regulator circuit and the bias generation circuit may amplify input signals with a desired gain over an improved bandwidth, provide output signals with improved out of band signal rejection, improve a product of gain and bandwidth of the LDO circuitry for receiving the input signals and providing the output signals, and/or reduce gain variations of the output signals across process, voltage, and/or time variations.

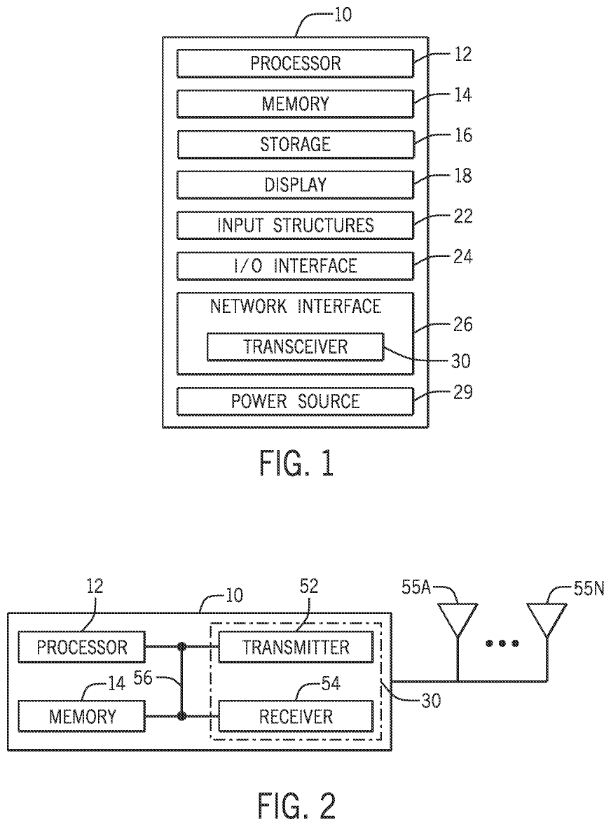

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter. The power source 29, the transceiver 30, or any other component of the electronic device 10 may include (or be coupled to) an LDO circuitry to provide a supply voltage to one or more of the electrical components of the electronic device 10.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The electronic device 10 may include the transmitter 52 and/or the receiver 54 that respectively enable transmission and reception of signals between the electronic device 10 and an external device via, for example, a network (e.g., including base stations or access points) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

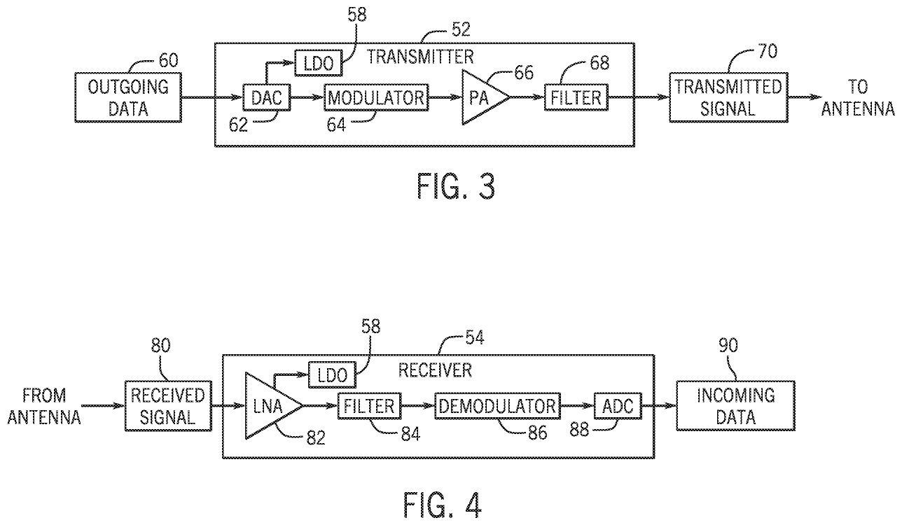

FIG. 3 is a schematic diagram of the transmitter 52 (e.g., transmit circuitry), according to embodiments of the present disclosure. As illustrated, the transmitter 52 may receive outgoing data 60 in the form of a digital signal to be transmitted via the one or more antennas 55. A digital-to-analog converter (DAC) 62 of the transmitter 52 may convert the digital signal to an analog signal, and a modulator 64 may combine the converted analog signal with a carrier signal to generate a radio wave. A power amplifier (PA) 66 receives the modulated signal from the modulator 64. In some embodiments, the DAC 62 may include the modulator 64. The power amplifier 66 may amplify the modulated signal to a suitable level to drive transmission of the signal via the one or more antennas 55. A filter 68 (e.g., filter circuitry and/or software) of the transmitter 52 may then remove undesirable noise from the amplified signal to generate transmitted signal 70 to be transmitted via the one or more antennas 55. The filter 68 may include any suitable filter or filters to remove the undesirable noise from the amplified signal, such as a bandpass filter, a bandstop filter, a low pass filter, a high pass filter, and/or a decimation filter.

The power amplifier 66 and/or the filter 68 may be referred to as part of a radio frequency front end (RFFE), and more specifically, a transmit front end (TXFE) of the electronic device 10. Additionally, the transmitter 52 may include any suitable additional components not shown, or may not include certain of the illustrated components, such that the transmitter 52 may transmit the outgoing data 60 via the one or more antennas 55. For example, the transmitter 52 may include a mixer and/or a digital up converter. As another example, the transmitter 52 may not include the filter 68 if the power amplifier 66 outputs the amplified signal in or approximately in a desired frequency range (such that filtering of the amplified signal may be unnecessary).

In some cases, the DAC 62 of the transmitter 52 may include a Class-D-like switched-capacitor radio frequency digital-to-analog converter (SC-RFDAC). It may be desired that an LDO regulator (e.g., an LDO circuitry discussed above) for the DAC 62, for New Radio (NR) Frequency Range 1 (FR1) applications, provide sufficient or increased power supply rejection ratio (PSRR) (e.g., between 15 decibels (dB) and 20 dB) for a certain frequency range (e.g., 10 megahertz (MHz) to 500 MHz). Accordingly, in the depicted embodiment, an LDO circuitry 58 may provide a supply voltage to the DAC 62. It should be appreciated that the LDO circuitry 58 may provide the supply voltage to one or more other electrical components of the transmitter 52 as well. For example, the frequency range may be derived from out-of-band emission requirements. It may also be desired that the LDO regulator provide sufficient or increased load regulation (e.g., less than 20 millivolts (mV) at 600 milliAmps (mA) peak current) for a certain frequency range (10 MHz to 200 MHz). For example, the frequency range may be derived from a maximum support signal bandwidth.

The disclosed embodiments include a fast loop amplifier that provides LDO regulation for a certain frequency range (e.g., 10 MHz to 1000 MHz). In one embodiment, the fast loop amplifier may include a two-stage amplifier that decouples gain from bandwidth. In another embodiment, the LDO regulator includes an alternating current (AC) coupling capacitor having increased capacitance (e.g., twice that of a load capacitance) and adding one or more gate blocking capacitors. For example, increasing the capacitance value of the AC coupling capacitor may correspond to increasing a gain of the LDO regulator. At least for some frequency ranges, the load capacitance may include or be estimated by a sum of a capacitance of the one or more gate blocking capacitors and AC coupling capacitor, as well as parasitic capacitances (e.g., a gate-to-drain parasitic capacitance and a gate-to-source parasitic capacitance) of the fast loop amplifier.

FIG. 4 is a schematic diagram of the receiver 54 (e.g., receive circuitry), according to embodiments of the present disclosure. As illustrated, the receiver 54 may receive received signal 80 from the one or more antennas 55 in the form of an analog signal. A low noise amplifier (LNA) 82 may amplify the received analog signal to a suitable level for the receiver 54 to process. A filter 84 (e.g., filter circuitry and/or software) may remove undesired noise from the received signal, such as cross-channel interference. The filter 84 may also remove additional signals received by the one or more antennas 55 that are at frequencies other than the desired signal. The filter 84 may include any suitable filter or filters to remove the undesired noise or signals from the received signal, such as a bandpass filter, a bandstop filter, a low pass filter, a high pass filter, and/or a decimation filter. The low noise amplifier 82 and/or the filter 84 may be referred to as part of the RFFE, and more specifically, a receiver front end (RXFE) of the electronic device 10. In some embodiments, the receiver 54 may include LDO circuitry (e.g., the LDO circuitry 58) providing a supply voltage to the LNA 82. It should be appreciated that the LDO circuitry 58 may provide the supply voltage to one or more other electrical components of the receiver 54 as well.

A demodulator 86 may remove a radio frequency envelope and/or extract a demodulated signal from the filtered signal for processing. An analog-to-digital converter (ADC) 88 may receive the demodulated analog signal and convert the signal to a digital signal of incoming data 90 to be further processed by the electronic device 10. Additionally, the receiver 54 may include any suitable additional components not shown, or may not include certain of the illustrated components, such that the receiver 54 may receive the received signal 80 via the one or more antennas 55. For example, the receiver 54 may include a mixer and/or a digital down converter. The electronic device 10 and/or the components therein (e.g., the processing circuitry 12, the transceiver 30, the transmitter 52, the receiver 54, and so on) may include any of the devices or systems and/or perform any of the techniques, methods, or processes described in the attached Appendix, which is incorporated herein in its entirety.

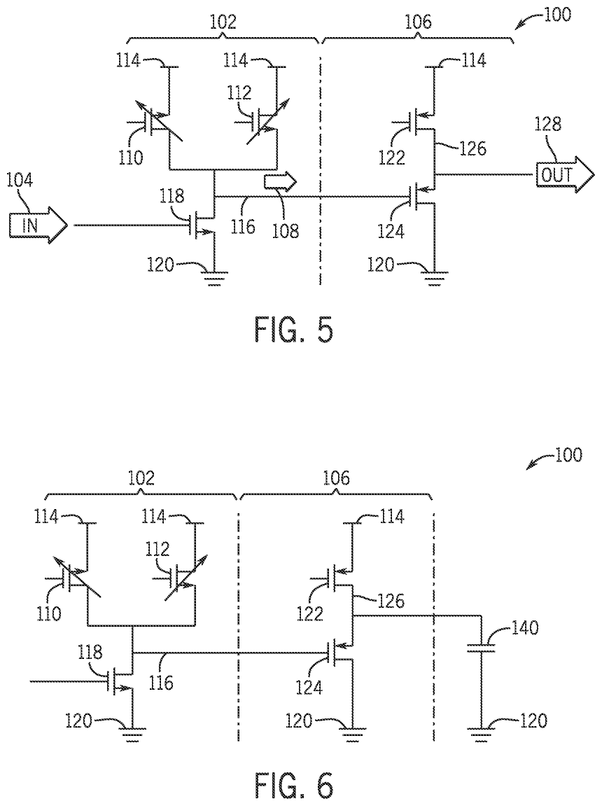

As mentioned above, the LDO circuitry 58 may include an LDO regulator circuit and a bias generating circuit. Moreover, the LDO regulator circuit may include a two-stage amplifier (e.g., the fast loop amplifier discussed above), an alternating current coupling capacitor, and one or more gate blocking coupling capacitors, among other things. If not compensated for, increasing a gain of an amplifier may reduce an operational bandwidth of the amplifier. FIG. 5 depicts a two-stage amplifier 100 including a first stage 102 for amplifying input signals 104 with a desired gain and a second stage 106 for providing an amplified signal 108 (e.g., output by the first stage 102) with a desired bandwidth. As such, the two-stage amplifier 100, hereinafter referred to as the amplifier 100, may amplify the input signals 104 with a desired gain over an improved bandwidth.

The first stage 102 of the amplifier 100 may include a first transistor 110 illustrated as a P-channel metal-oxide-semiconductor field-effect transistor (PMOS) and a second transistor 112 illustrated as an N-channel metal-oxide-semiconductor field-effect transistor (NMOS). The first transistor 110 and the second transistor 112 may receive an input voltage 114 from a voltage source (not shown) on a first terminal and coupled to the second stage 106 via a first node 116 and a second terminal. For example, a source of the first transistor 110 and a drain of the second transistor 112 may receive the input voltage 114. The first stage 102 of the amplifier 100 may also include a third transistor 118 illustrated as an NMOS coupled to the second stage 106 via a first (e.g., source) terminal and the first node 116 and coupled to a ground connection 120 (e.g., 0 volts, virtual ground) via a second (e.g., drain) terminal (e.g., drain). A gate of the third transistor 118 may couple to an input port of the amplifier to receive the input signals 104. Moreover, gates of the first transistor 110, the second transistor 112, and the third transistor 118 may couple to respective replica transistors of the bias generation circuitry to receive biasing signals, as will be appreciated. The first stage 102 may provide one or more amplified signals 108 to the second stage 106 via the first node 116. For example, the first stage 102 may provide the amplified signals 108 with a desired gain (e.g., higher than a gain factor of 1) based on receiving one or more input signal 104.

The second stage 106 of the amplifier 100 may include a fourth transistor 122 and a fifth transistor 124 illustrated as a PMOS. A first (e.g., source) terminal of the fourth transistor 122 may receive the input voltage 114 and a second (e.g., drain) terminal of the fourth transistor 122 may couple to a first (e.g., drain) terminal of the fifth transistor 124 via a second node 126. A second (e.g., source) terminal of the fifth transistor 124 may couple to the ground connection 120. A gate of the fourth transistor 122 may couple to a replica transistor of the bias generation circuitry to receive a biasing signal, as will be appreciated. Moreover, a gate of the fifth transistor 124 may couple to the first node 116 to receive the amplified signals 108. An output port of the amplifier 100 may couple to the fourth transistor 122 and the fifth transistor 124 via the second node 126. For example, the second stage 106 may provide an output signal 128 based on a voltage difference between the first node 116 and the second node 126 of the amplifier 100. In some cases, a first current in the first stage (e.g., through the third transistor 118) is half of a second current in the second stage (e.g., through the fourth transistor 122) during operation of the amplifier 100. In specific cases, the amplifier 100 may provide the output signal 128 with a voltage value based on a gate-source voltage (e.g., V_{GS}) of the fifth transistor 124.

In any case, the second stage 106 may provide the output signal 128 over an improved (e.g., increased or wider) bandwidth compared to the first stage 102. In some cases, the second stage 106 may provide the output signal 128 without changing a gain of the amplified signal 108 (e.g., a voltage buffer, a gain of 1, a gain close to 1) via the output port of the amplifier 100. In specific cases, the second stage 106 may provide the output signal 128 with a constant and/or predetermined current. Moreover, a first pole of the first stage 102 may be higher than a second pole of the second stage 106. Accordingly, the second stage 106 may provide the output signal 128 with a desired bandwidth. For example, the amplifier 100 may provide the output signal 128 with an improved out-of-band signal rejection. While the transistors 110, 112, 118, 122, and 124 are illustrated as PMOS or NMOS transistors, in additional or alternative embodiments, different transistors are contemplated in their place.

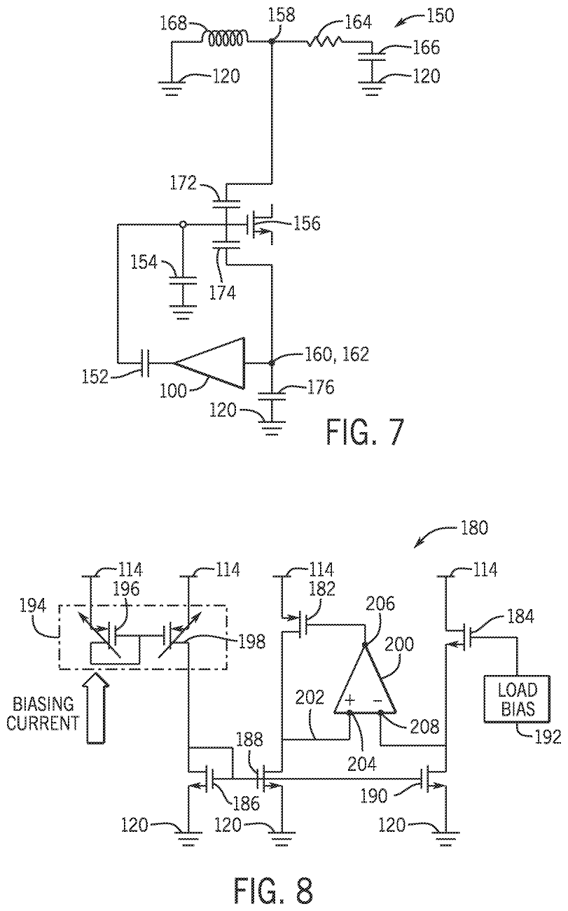

FIG. 6 depicts the amplifier 100 coupled to an effective load capacitance 140 of the amplifier 100 when an LDO regulator circuit includes the amplifier 100. For example, an aggregate capacitance of the LDO regulator circuit, described below, may correspond to a capacitance value of the effective load capacitance 140. That is, the effective load capacitance 140 may correspond to capacitance at the output port of the amplifier 100. Moreover, FIG. 7 depicts an LDO regulator circuit 150 including the amplifier 100. The output port of the amplifier 100 may couple to an alternating current coupling capacitor 152. The alternating current coupling capacitor 152 may couple to a first terminal of the gate blocking coupling capacitor 154 and a gate of an output transistor 156 (e.g., illustrated as an NMOS, but it is contemplated other switching circuitry may be used, such as a PMOS) of the LDO circuitry 58. Although one gate blocking coupling capacitor 154 is shown, alternatively or additionally, the amplifier 100 may include multiple capacitors having equivalent capacitance to the depicted gate blocking coupling capacitor 154. A second terminal of the gate blocking coupling capacitor 154 may couple to the ground connection 120. The output transistor 156 may couple to a first input port 158 of the LDO circuitry 58 on a first (e.g., a) terminal and may couple to a second input port 160 and an output port 162 of the LDO circuitry 58 on a second (e.g., source) terminal. The first input port 158 may also couple to a resistor 164, a capacitor 166, and an inductor 168. For example, the resistor 164, the capacitor 166, the inductor 168, and parasitic capacitances of the LDO regulator circuit 150 may form a resonant circuit associated with rejecting input signals out of a frequency band. In any case, the output port 162 may provide the supply voltage to one or more downstream electrical components (e.g., the DAC 62, the LNA 82, among other things).

Referring back to FIG. 6, the effective load capacitance 140 may have a different capacitance value based on whether the output transistor 156 is in saturation region, in sub-threshold region, or on linear region. In the depicted embodiment, when the output transistor 156 is open (e.g., deactivated, in sub-threshold region), the amplifier 100 may include a gate-source parasitic capacitance 174 coupled to a source and the gate of the output transistor 156 during operation of the amplifier 100. The amplifier 100 may also include a gate-drain parasitic capacitance 172 coupled to a drain and the gate of the output transistor 156 during operation of the amplifier 100. An effective gate capacitance (CG_EFF) of the output transistor 156 may be the weighted aggregate of the gate-drain 172 and gate source capacitance 174. A first weight of the gate-drain capacitance 172 (CGD) as part of the weighted aggregate (CG_EFF) may be based on an operational state (e.g., in saturation region, in sub-threshold region, or in linear region) of the output transistor 156. Moreover, a second weight of the gate-source capacitance 174 (CGS) as part of the aggregate (CG_EFF) may be based on the operation of the output transistor 156, as shown in equation 1 below.

CG_EFF=CGD*coeff1+CGS*coeff2 (Equation 1)

Moreover, the first weight and the second weight may have different values (e.g., coeff1 and coeff2, respectively) based at least in part on different operational states of the output transistor 156. A capacitance value of the effective load capacitance 140 (C_{LOAD_EFF}) may be equal or close to an aggregate of capacitance values of the gate blocking coupling capacitor 154 (CG_{BLK}), a scaled gate-drain parasitic capacitance 172 (CGD) based on the first weight, and a scaled gate-source parasitic capacitance 174 (C_{GS}) based on the second weight. The scaled gate-drain parasitic capacitance 172 (CGD) and the scaled gate-source parasitic capacitance 174 (C_{GS}) may be in series with the alternating current capacitor 152 (CAC_FL). Equation 2 may correspond to a value of the effective load capacitance 140):

$${C}_{LOAD \_ EFF} = CAC\_FL * \frac{CG\_EFF + {CG}_{BLK}}{CAC\_FL + CG\_EFF + {CG}_{BLK}} \qquad ( Equation 2 )$$

This equation represents all output transistor regions and independently of frequency. In some cases, the alternating current coupling capacitor 152 (CAC_FL) may have increased capacitance equal to or near twice that of the aggregate of the gate-blocking capacitor 154 (CG_{BLK}) and the weighted aggregate of the gate-drain capacitor 172 (CGD) and the gate-source capacitance 174 (CGS).

For example, the gate-to-drain parasitic capacitance 172 and the gate-to-source parasitic capacitance 174 may each be 20 picofarads (pF) or less, 10 pF or less, 5 pF or less, 3 pF or less, such as 3 pF, and a capacitance of a gate blocking coupling capacitor 154 may be 50 pF or less, 20 pF or less, 10 pF or less, such as 10 pF. As such, in some cases, a capacitance of the alternating current coupling capacitor 152 may be 200 pF or less, 150 pF or less, 100 pF or less, 50 pF or less, such as 32 pF. Such may be the case when representing a worst case (e.g., increased or highest value) of the capacitance at the input of the amplifier 100 across a desired frequency range (e.g., an improved TX frequency band). The alternating current coupling capacitor 152 and the gate blocking coupling capacitor 154 may improve base open-loop power supply rejection ratio (PSRR) and load regulation.

In any case, the alternating current coupling capacitor 152 and the gate blocking coupling capacitor 154 may improve a rejection of out-of-band (e.g., out of transmission band) signals of the amplifier 100.

Moreover, the second stage 106 may improve the product of gain and bandwidth of the LDO regulator circuit 150 based on the effective load capacitance 140. For example, a bandwidth (BW) of the amplifier 100 may be determined based on a quotient obtained by dividing the transconductance of the fifth transistor 124 of the amplifier 100 (GM_{OUT}) and the effective load capacitance 140. Alternatively or additionally, the bandwidth (BW) of the amplifier 100 may be determined by dividing the transconductance of fifth transistor 124 of the amplifier 100 by a quotient obtained by dividing a multiplication of capacitance values of the alternative current coupling capacitor 152 and the weighted aggregate of the gate-blocking coupling capacitance 154, the gate-drain capacitance 172, and the gate-source capacitance 174 over a weighted aggregate of capacitance values of the alternative current coupling capacitor 152, the gate-blocking coupling capacitance 154, the gate-drain capacitance 172, and the gate-source capacitance 174 as shown in Equation 3:

$$BW \approx \frac{{GM}_{OUT}}{{C}_{LOAD \_ EFF}} \approx \frac{{GM}_{OUT}}{CAC\_FL * \frac{CG\_EFF + {CG}_{BLK}}{CAC\_FL + CG\_EFF + {CG}_{BLK}}} \qquad ( Equation 3 )$$

As such, in some cases, the alternating current coupling capacitor 152 and the gate blocking coupling capacitor 154 may improve the product of gain and bandwidth of the LDO regulator circuit 150 (GBW_{ACTIVE}) based on a quotient obtained by dividing a multiplication of a gain of the first stage 102 (G_{INPUT}) and a transconductance of the second stage output transistor 100 (GM_{OUT}) over the capacitance value of the effective load capacitance 140 as shown in Equation 4:

$${GBW}_{ACTIVE} \approx \frac{{G}_{INPUT} \times {GM}_{OUT}}{{C}_{LOAD \_ EFF}} \qquad ( Equation 4 )$$

The two-stage amplifier 100, the alternating current coupling capacitor 152, and the gate blocking coupling capacitor 154 may improve the PSRR, a bandwidth of a desired power supply rejection ratio value, or both. For example, the LDO regulator circuit 150 may provide a desired power supply rejection ratio (e.g., between 15 decibels (dB) and 20 dB) for out-of-band (e.g., out of transmission band) signals over an improved frequency range (e.g., 10 megahertz (MHz) to 500 MHz).

FIG. 8 depicts a bias generation circuit 180 of the LDO circuitry 58. The bias generation circuit 180 may include a first replica transistor 182 illustrated as a PMOS, a second replica transistor 184 illustrated as an NMOS, a third replica transistor 186 illustrated as an NMOS, a fourth replica transistor 188 illustrated as an NMOS, and a fifth replica transistor 190 illustrated as an NMOS. The replica transistors 182, 184, 186, 188, and 190 may provide biasing signals to the gates of the first transistor 110, the second transistor 112, the third transistor 118, and the fourth transistor 122 of the LDO regulator circuit 150 of FIG. 7. The biasing signals may refer to voltages or currents (e.g., a direct current signal) applied to a gate of a switch (e.g., a transistor) to activate the switch. For example, the first replica transistor 182 may include a p-channel metal-oxide semiconductor (pMOS) transistor, the second replica transistor 184, the third replica transistor 186, the fourth replica transistor 188, and the fifth replica transistor 190 may include an n-channel metal-oxide semiconductor (nMOS) transistor.

A gate of the first transistor 110 and the fourth transistor 122 may couple to a gate of the first replica transistor 182 to form a current mirror. Moreover, a gate of the second transistor 112 may couple to a gate of the second replica transistor 184 to form a current mirror. The bias generation circuit 180 may include (or be coupled to) a load bias circuit 192 coupled to the gate of the second replica transistor 184 to provide a biasing voltage. Furthermore, a gate of the third transistor 118 may couple to a gate of the third replica transistor 186, the fourth replica transistor 188, and the fifth replica transistor 190 forming a current mirror. In the depicted embodiment, a first (e.g., drain) terminal of one of the third replica transistor 186 may couple to an output of a current mirror 194 including a first current mirroring transistor 196 and a second current mirroring transistor 198. A first terminal of the fourth replica transistor 188 may couple to the first replica transistor 182, a non-inverting input of the operational amplifier.

In the depicted embodiment, the first current mirroring transistor 196 illustrated as a PMOS may receive a biasing current to activate at least a portion of the bias generation circuit 180. The current mirror 194 may couple to a biasing current source to receive the biasing current. The second current mirroring transistor 198 illustrated as a PMOS may provide an activation current based on the biasing current. Moreover, the load bias circuit 192 may provide the biasing voltage to the gate of the second replica transistor 184 to activate at least a portion of the bias generation circuit 180. Activating the bias generation circuit 180 may bias the gates of the first transistor 110, the second transistor 112, the third transistor 118, and the fourth transistor 122 of the LDO regulator circuit 150. In turn, the LDO regulator circuit 150 may generate a supply voltage. The LDO regulator circuit 150 may provide supply voltage to one or more downstream components (e.g., the DAC 62, the LNA 82, among other things), for example, via the output port 162, as discussed above. While the transistors 182, 184, 186, 188, 190, 196, and 198 are illustrated as PMOS or NMOS transistors, in additional or alternative embodiments, different transistors are contemplated in their place.

The bias generation circuit 180 may include circuitry to improve stability of current density and gain ratio of the biasing signals. In particular, the bias generation circuit 180 may include an operational amplifier 200 (e.g., an operational transconductance amplifier) coupled to the first replica transistor 182, the second replica transistor 184, and the fourth replica transistor 188 to generate (e.g., replicate, resemble) a voltage of the second node 126 of the LDO regulator circuit 150 discussed above. For example, the operational amplifier 200 may generate the voltage of the second node 126 of the LDO regulator circuit 150 on a node 202 between a non-inverting input 204 of the operational amplifier 200, the first replica transistor 182, and the fourth replica transistor 188. Moreover, an inverting input 208 of the operational amplifier 200 may couple to the second replica transistor 184. Accordingly, the bias generation circuit 180 may reduce gain variations of one or more of the biasing signals across process, voltage, and time variations. It should be appreciated that the bias generation circuit 180 may couple to and/or provide biasing signals to any other viable circuit for activating such circuit. For example, the bias generation circuit 180 may couple to and/or provide biasing signals to amplification circuits and/or LDO regulator circuits not discussed here.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A two-stage amplifier comprising:
a first stage comprising
a first transistor,
a second transistor coupled to the first transistor, and
a third transistor coupled to the first transistor and the second transistor, a gate of the third transistor configured to receive an input signal;
a second stage comprising
a fourth transistor, and
a fifth transistor coupled to the fourth transistor, a gate of the fifth transistor coupled to the first transistor, the second transistor, and the third transistor, and configured to receive an amplified signal based on the input signal, the fifth transistor configured to provide an output signal based on the amplified signal.

2. The two-stage amplifier of claim 1, wherein the first transistor and the second transistor are configured to couple to a voltage source and the gate of the third transistor is configured to receive the input signal from a device external to the two-stage amplifier.

3. The two-stage amplifier of claim 1, wherein the output signal is provided at a node between the fourth transistor and the fifth transistor.

4. The two-stage amplifier of claim 1, wherein the output signal is based on a voltage difference between a first voltage of the amplified signal at the gate of the fifth transistor and a second voltage at a node between the fourth transistor and the fifth transistor.

5. The two-stage amplifier of claim 1, wherein the second stage comprises a voltage buffer.

6. The two-stage amplifier of claim 1, wherein a first current through the third transistor is half of a second current through the fifth transistor during operation.

7. The two-stage amplifier of claim 1, wherein a first pole of the first stage is higher than a second pole of the second stage.

8. The two-stage amplifier of claim 1, wherein the first transistor, the fourth transistor, and the fifth transistor each comprises a P-channel metal-oxide-semiconductor.

9. The two-stage amplifier of claim 1, wherein the second transistor and the third transistor each comprises a N-channel metal-oxide-semiconductor.

10. A low-dropout regulator circuit comprising:
a two-stage amplifier, a first stage of the two-stage amplifier configured to provide an amplified signal based on receiving an input signal, and a second stage of the two-stage amplifier configured to provide a first output signal based on the amplified signal, the second stage having a wider bandwidth than the first stage;
an alternating current coupling capacitor coupled to an output port of the two-stage amplifier;
a coupling capacitor coupled to the alternating current coupling capacitor; and
an output transistor configured to receive a first input signal at a first terminal and provide a second output signal at a second terminal, the second terminal being coupled to an input port of the two-stage amplifier, and a third terminal of the output transistor being coupled to the coupling capacitor and the alternating current coupling capacitor.

11. The low-dropout regulator circuit of claim 10, wherein a drain of the output transistor is configured to receive the first input signal and a source of the output transistor is configured to provide the second output signal.

12. The low-dropout regulator circuit of claim 11, wherein the source of the output transistor is configured to receive a second input signal.

13. The low-dropout regulator circuit of claim 10, comprising a load capacitor coupled to the second terminal of the output transistor and the input port of the two-stage amplifier.

14. The low-dropout regulator circuit of claim 13, wherein a capacitance value of the load capacitor is based on an aggregate capacitance value of the coupling capacitor and one or more parasitic capacitances of the output transistor during operation.

15. The low-dropout regulator circuit of claim 10, wherein a capacitance value of the alternating current coupling capacitor is twice a capacitance value of an effective load capacitance of the alternating current coupling capacitor, the coupling capacitor, and the output transistor during operation.

16. Low-dropout circuitry comprising:
a low-dropout regulator circuit comprising a two-stage amplifier having a plurality of transistors; and
a bias generation circuit comprising
an operational amplifier,
a first current mirror circuit;
a first replica transistor comprising
a first terminal coupled to an input voltage,
a second terminal being coupled to an output of the operational amplifier and a first transistor of the plurality of transistors, and
a third terminal;
a second replica transistor comprising
a fourth terminal coupled to the input voltage,
a fifth terminal coupled to a load bias circuit and a second transistor of the plurality of transistors, and
a sixth terminal coupled to an inverting input of the operational amplifier, and a third replica transistor comprising
a seventh terminal coupled to the first current mirror circuit, an eighth terminal of the third replica transistor, and a third transistor of the plurality of transistors,
the eighth terminal, and
a ninth terminal being coupled to a ground connection.

17. The low-dropout circuitry of claim 16, wherein the bias generation circuit comprises a fourth replica transistor having a tenth terminal coupled to a non-inverting input of the operational amplifier and the third terminal, an eleventh terminal coupled to the third transistor, and a twelfth terminal coupled to the ground connection.

18. The low-dropout circuitry of claim 17, wherein the bias generation circuit comprises a fifth replica transistor having a thirteenth terminal coupled to the sixth terminal and the inverting input of the operational amplifier, a fourteenth terminal coupled to the eighth terminal, the non-inverting input of the operational amplifier, the third terminal, the eleventh terminal, and the third transistor, and a fifteenth terminal coupled to the ground connection.

19. The low-dropout circuitry of claim 18, wherein the second terminal forms a second current mirror circuit with a gate of the first transistor, the fifth terminal forms a third current mirror circuit with a gate of the second transistor, and the eighth terminal, the eleventh terminal, and the fourteenth terminal form a fourth current mirror circuit with a gate of the third transistor.

20. The low-dropout circuitry of claim 16, wherein the first current mirror circuit is coupled to a biasing current source.
